(19) United States
(12) Patent Application Publication
(10) Pub. No.: US 2026/0038930 A1
(43) Pub. Date: Feb. 5, 2026

(54) COIN CELL BATTERY HOLDER WITH SAFETY MECHANISMS

(71) Applicant: Dell Products L.P., Round Rock, TX (US)

(72) Inventors: JER-YO LEE, Taipei City (TW); CHUN-TING LU, New Taipei City (TW); CHENG-HSIANG CHUANG, New Taipei City (TW); YO-HUANG CHANG, Taipei City (TW); HSIEN-WEI CHEN, New Taipei City (TW); HENG-FU KUO, Taipei City (TW); SHIH-LUN HUANG, New Taipei City (TW)

(21) Appl. No.: 18/790,967

(22) Filed: Jul. 31, 2024

(51) Int. Cl. H01M 50/216; H01M 50/109; H01M 50/181; H01M 50/202

(52) U.S. Cl. CPC H01M 50/216; H01M 50/109; H01M 50/181; H01M 50/202

(57) ABSTRACT

Methods and systems for providing computer implemented services are disclosed. To provide the computer implemented services, a battery holder may be used to ensure that hardware components are provided with power. The battery may provide power while other sources of power are unavailable. The hardware components may use the power to retain data while other sources of power is unavailable. The battery holder may include multiple mechanisms to manage release of batteries from the battery holder.

### FIELD

Embodiments disclosed herein relate generally to power management. More particularly, embodiments disclosed herein relate to systems and methods to manage power for data processing systems.

### BACKGROUND

Computing devices may provide computer implemented services. The computer implemented services may be used by users of the computing devices and/or devices operably connected to the computing devices. The computer implemented services may include hardware components that provide the computer implemented services. The hardware components may consume power and generate heat as a byproduct of performing the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2L show diagrams illustrating a battery holder, or portions thereof, in accordance with an embodiment.

FIG. 3 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer implemented services. To provide the computer implemented services, various hardware components may perform different functions. When performing the functions, the hardware components may consume power.

To improve the likelihood of power being available, a battery holder for holding a battery may be used. The battery holder may hold a battery used to provide power to some hardware components while other sources of power are unavailable. The power may be provided so that information is not lost by the hardware components. For example, loss of power may cause the hardware components to lose information such as hardware configuration settings, program code, etc.

To reduce the likelihood of undesired release of batteries from battery holders, the battery holder may include multiple mechanisms for releasing batteries. The mechanism may require performance of specific sets of steps for the battery to be released from the holder. Accordingly, children or other persons may be less likely to be able to remove the batteries from the data processing systems.

Thus, embodiments disclosed herein may address, among others, the technical problem of securing dangerous components within data processing systems. The dangerous components may be secured using battery holders that include multiple mechanisms for securing batteries within the battery holders. By securing the dangerous components, potentially dangerous components of data processing systems may be less likely to be released from the data processing systems. Accordingly, such battery holders and host data processing systems may present reduced levels of risk to users thereof, and other persons proximate to the battery holders (e.g., such as children that may swallow or otherwise use batteries improperly.

In an embodiment, a data processing system is provided. The data processing system may include hardware components; and a battery holder for a coin cell battery, the battery holder comprising: a holder to secure the coin cell battery in the battery holder, the holder comprising a release mechanism to release the battery using an application of a first force; and a stopper adapted to prevent the application of the first force from releasing the battery unless a second force is applied to the stopper while the first force is applied to the release mechanism.

The battery holder may also include a cover set to cover sides and a top of the coin cell battery.

The cover set may include a circumscribing component to cover the sides of the battery holder; and a cap to cover the top of the battery holder.

The cap may be rotatably coupled to the circumscribing component on a first side and may be reversibly secured to the stopper on a second side.

The stopper may include a body adapted for attachment to the holder; a pair of extension elements that extend from the body, the pair of extension elements being adapted to: move to an at rest position while the second force is not applied, the pair of extension elements establishing an interference with the release mechanism while in the at rest position.

An extension of the pair of extensions may include a cover catch portion adapted to reversibly secure the cover in a closed position; an interference portion adapted to, at least in part, establish the interference with the release mechanism; and a joint to rotate the cover catch portion and the interference portion between three positions.

While the cover catch portion is in a first position of the three positions, the cover catch portion may establish an interference with a tab of the cover that retain the cover in the closed position.

While the cover catch portion is in either of a second position and a third position of the three positions, the interference with the tab of the cover may be released to allow the cover to move to an open position.

While the interference portion is in either of the first position and the second position of the three positions, the interference portion may establish the interference with the release mechanism.

While the interference portion is in the third position of the three positions, the interference with the release mechanism may be released to enable actuation of the release mechanism.

In an aspect, a battery holder as discussed above is provided.

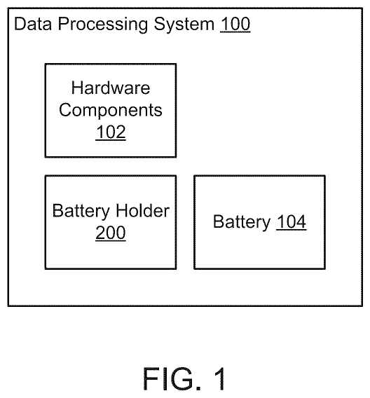

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, transaction processing services, and/or any other type of service that may be implemented with a computing device.

To provide the computer implemented services, the system may include any number of data processing system 100. Data processing system 100 may provide the computer implemented services in combination with and/or separately from other data processing systems.

To provide the computer implemented services, data processing system 100 may host various hardware components 102. Some of the hardware components may rely on having access to previously stored information. For example, during startups of data processing system 100, various portions of program code, configuration settings, and/or other information may be utilized. If access to such data is unavailable, then data processing system 100 may be unable to complete startups and/or other procedures required for it to provide desired computer implemented services by users.

In general, embodiments disclosed herein may provide methods, systems, and/or devices for providing computer implemented services. To provide the computer implemented services, hardware components 102 of data processing system may load information from storage devices. To reduce the likelihood of such data from being lost, data processing system 100 may include a battery used to power storage devices while sources of other power are unavailable. By utilizing a battery, supplementary power may be provided to components of data processing system while primary power is unavailable. Thus, data processing system 100 may be less likely to be negatively impacted by temporary losses of power.

To provide the above noted functionality, the system of FIG. 1 may include hardware components 102, battery 104, and battery holder 200. Each of these components is discussed below.

As discussed above, hardware components 102 may include any number and type of hardware components usable to provide computer implemented services. All or a portion of hardware components 102 may require access to stored information. Some or all of the stored information may be stored in components that rely on access to power to retain the stored information. For example, various setting and/or other information (e.g., basic input output system settings, program code, etc.) used to perform startups of data processing system 100 may be stored in such storage devices. The storage components may include Complementary Metal Oxide Semiconductor (CMOS) devices which may require continuous access to power to retain stored information.

Battery 104 may be a batter usable to supply power to the storage devices of hardware components 102 when primary power is unavailable. While not shown, data processing system 100 may include power supplies that obtain power from other sources, convert it to power usable by hardware components 102, and provide hardware components 102 with such power. However, the power supplies may only be able to provide such power while (i) operating, and (ii) the other sources of power (e.g., public utilities) are available. Battery 104 may serve as a backup that provides power while the primary sources of power for data processing system 100 are unavailable.

For example, battery 104 may be implemented using a coin cell battery. The coin cell battery may be connected to various hardware components 102 via circuit boards or other interconnect technologies.

Battery holder 200 may be a holder for battery 104. Battery holder 200 may be attached to a circuit board through which other hardware components are operably connected. Thus, when inserted in battery holder 200, battery 104 may provide power to retain information by hardware components 102 while power is unavailable from primary sources.

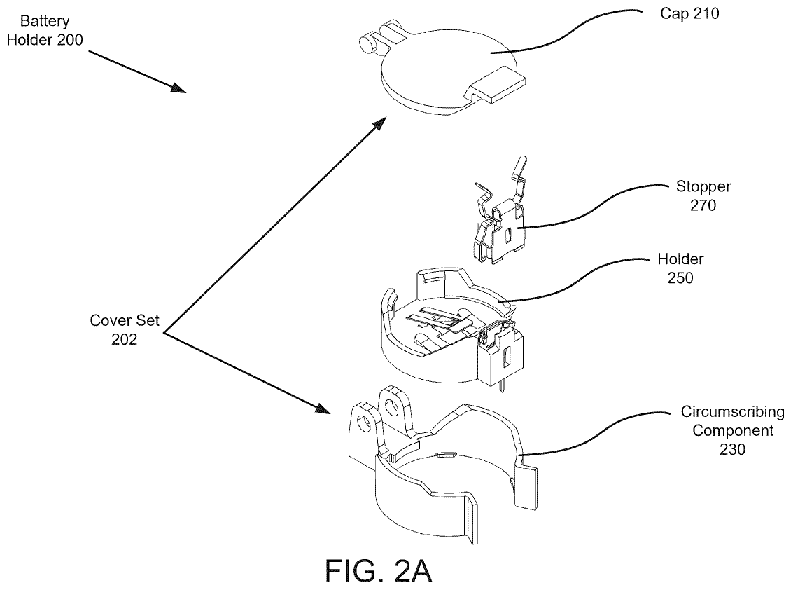

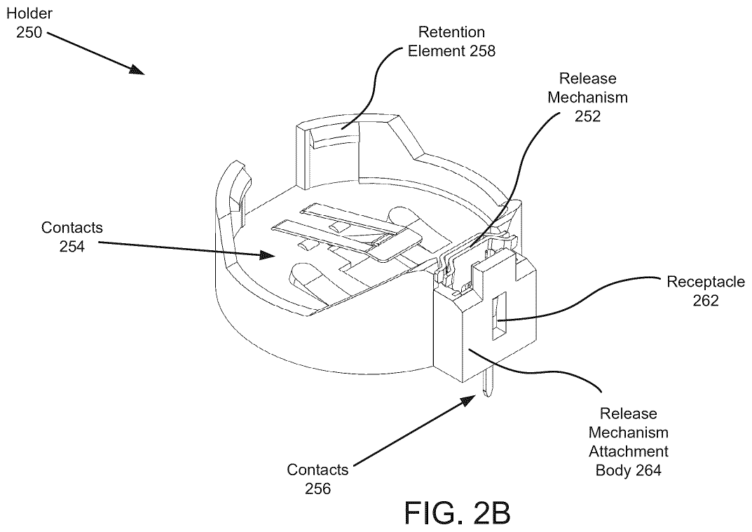

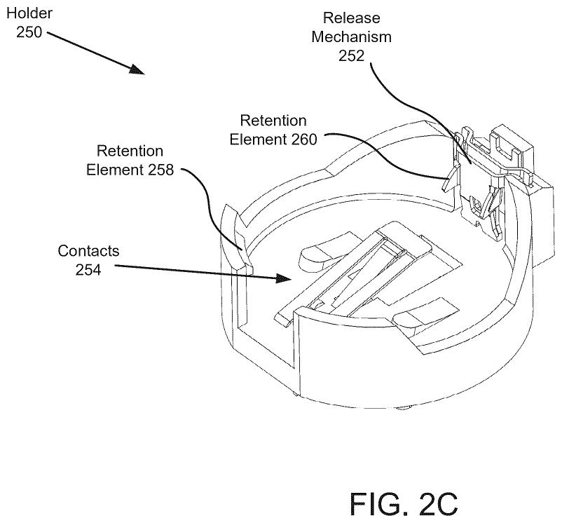

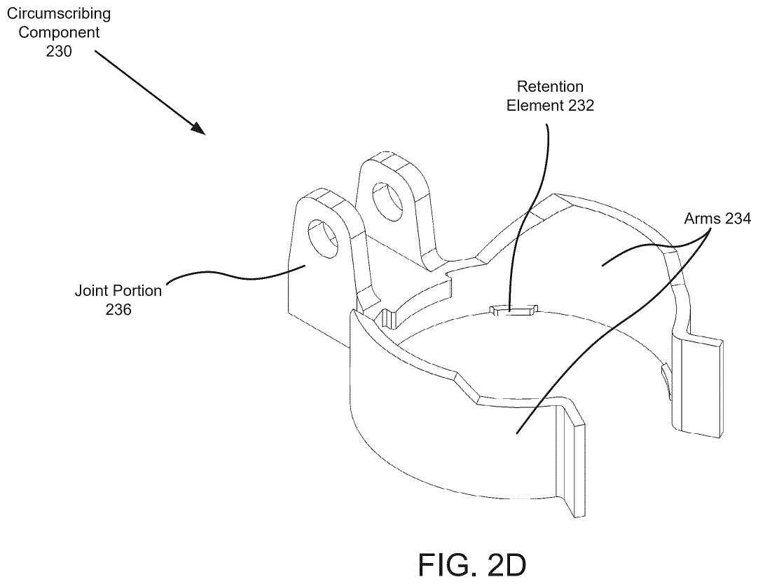

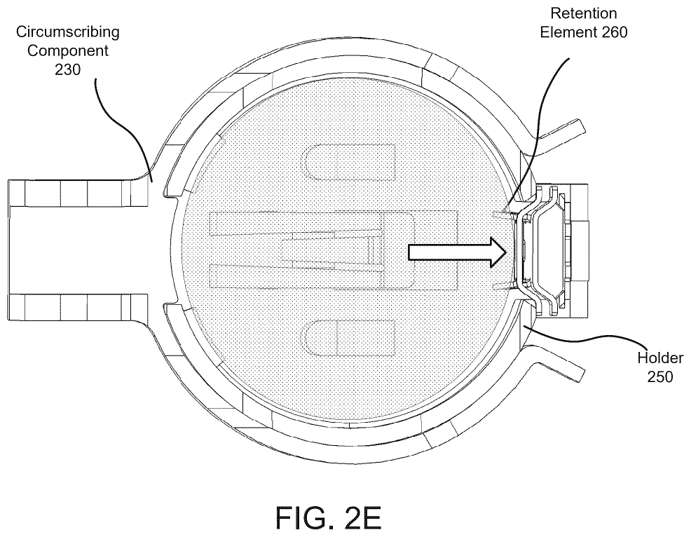

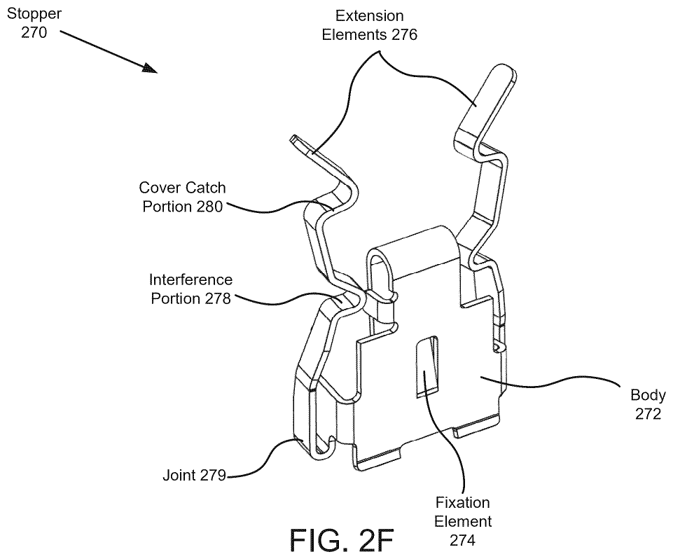

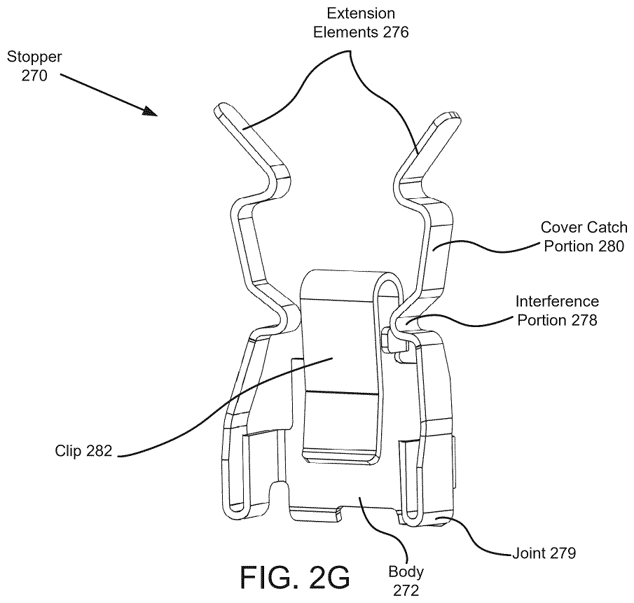

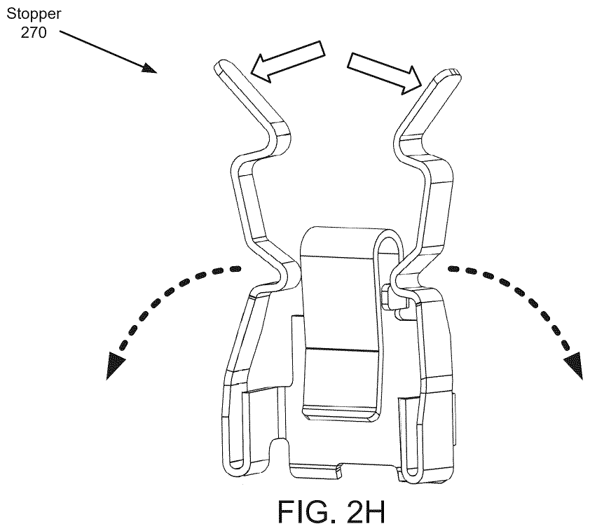

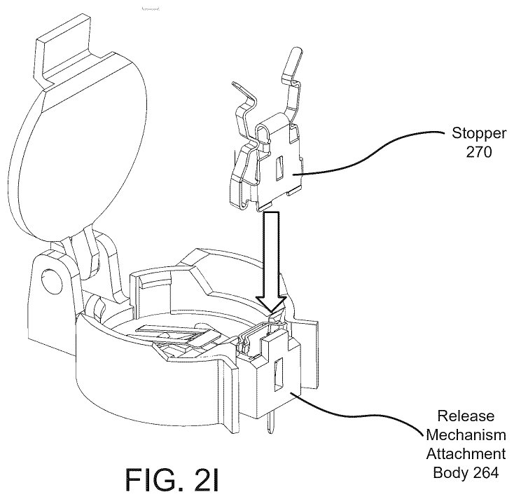

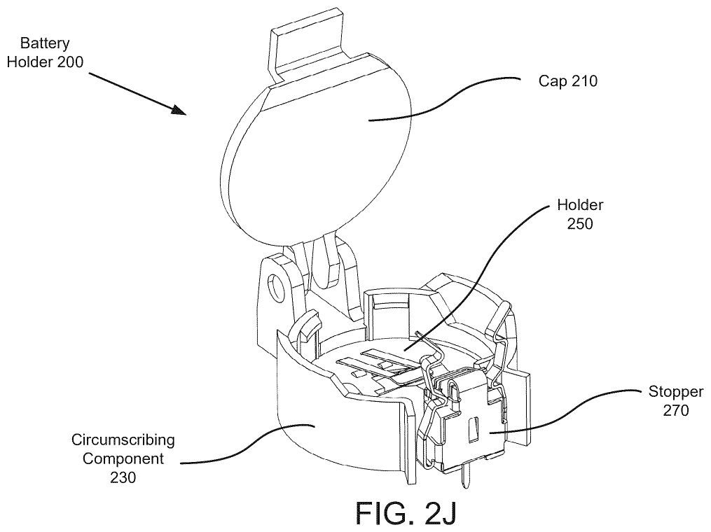

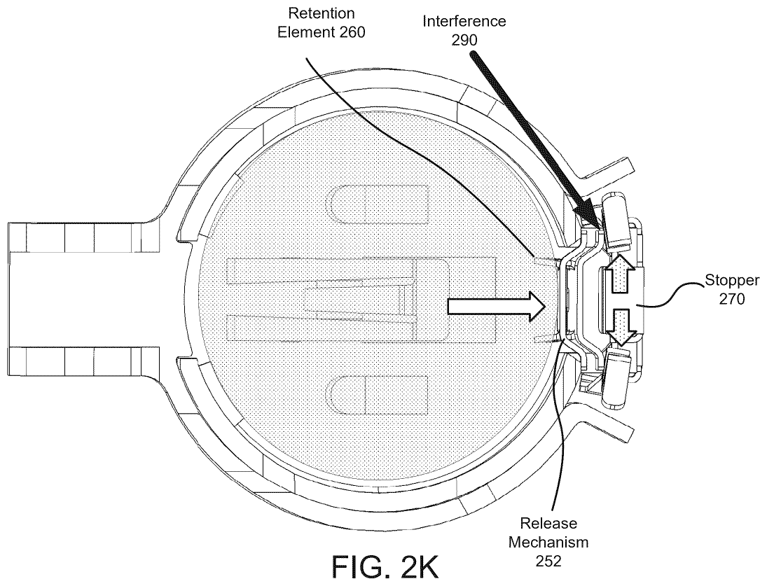

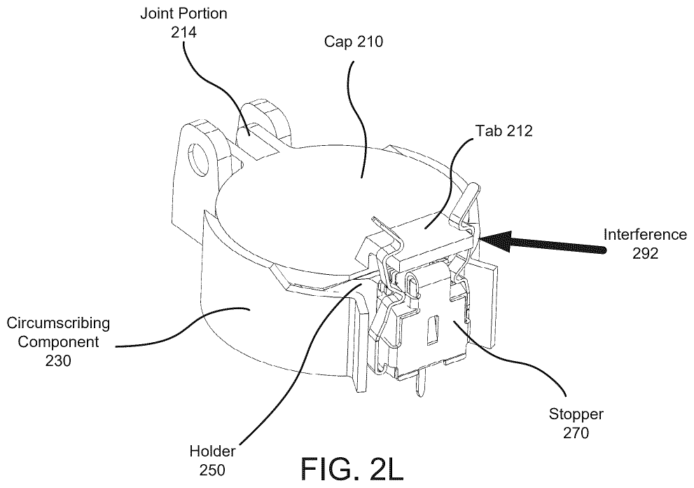

In addition, battery holder 200 may include multiple safety features that reduce the likelihood of battery 104 being removed form battery holder 200 undesirably. For example, if battery 104 is not effectively secured in battery holder 200, then battery 104 may be easily removed by children or other individuals. If removed, battery 104 may present choking hazards and/or other risks. It will be appreciated that if battery 104 is removed via other processes (e.g., jostling), then battery 104 may present similar hazards. By including multiple safety features that reduce the likelihood of battery 104 being removed from battery holder 200, the threats presented by battery 104 may be managed. Refer to FIGS. 2A-2L for additional information regarding battery holder 200.

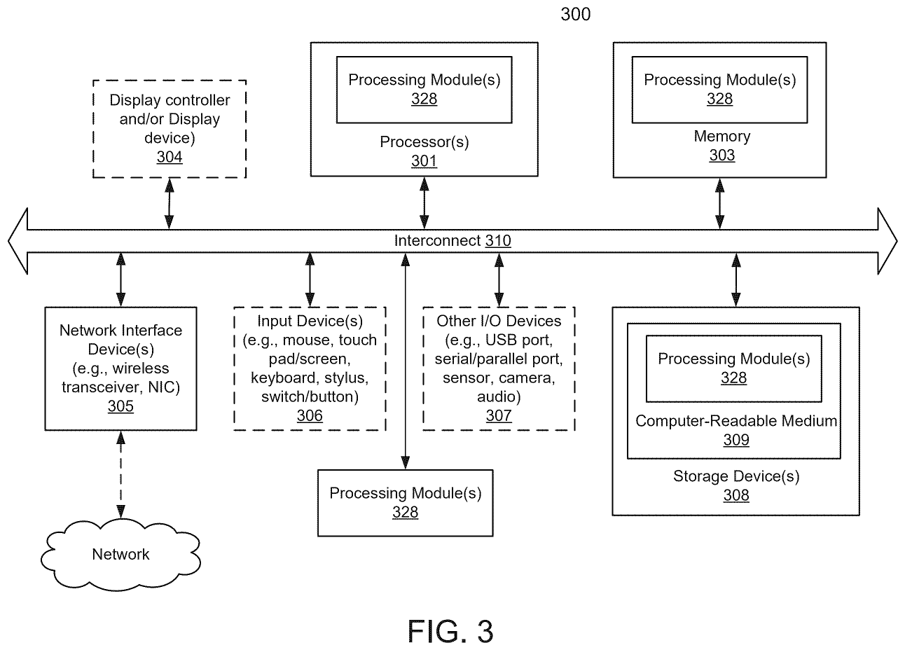

Any of (and/or components thereof) the data processing systems (e.g., 100) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 3.

Any of the components illustrated in FIG. 1 may be operably connected to each other (and/or components not illustrated) with a communication system. In an embodiment, the communication system includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

Turning to FIG. 2A, an exploded isometric view of battery holder 200 in accordance with an embodiment is shown. To provide it functionality, battery holder 200 may include cap 210, circumscribing component 230, holder 250, and stopper 270. Each of these components is discussed below.

Cap 210 may be a structural component for covering a top side of a battery. Generally, cap 210 may be rotatably connected to circumscribing component 230 on a first end, and a second end may be reversibly secured in a first position with stopper 270. Cap 210 may generally move between an open and a closed position (e.g., in which the battery may be accessed and may not be accessed), and such movement may be restricted by stopper 270. Refer to FIGS. 2I-2L for additional information regarding cap 210.

Circumscribing component 230 may be a structural component for covering side surfaces of a battery, and covering other components such as holder 250. For example, circumscribing component may surround various portions of holder 250, and a battery positioned therein. Refer to FIGS. 2D-2E and 2I-2L for additional information regarding circumscribing component 230.

Holder 250 may be a structural component for holding and interconnecting a battery with other components. For example, holder 250 may include an area for positioning the battery, interconnect for establishing electrical paths so that the battery may power other components, and at least one feature for securing the battery so that the battery is less likely to be undesirably (e.g., unexpectedly, without permission) removed from battery holder 200. Refer to FIGS. 2B-2E and 2I-2L for additional information regarding holder 250.

Stopper 270 may be a structural component for reducing the likelihood of undesirable removals of the battery from holder 250. Generally, stopper 270 may be affixed to holder 250, and may (i) prevent the feature of the holder from being actuated unless holder 250 is simultaneously actuated, and (ii) reversibly secure cap 210 in a closed position. By doing so, stopper 270 may further reduce the likelihood of undesirable removals of the battery from holder 250 by requiring multiple, simultaneous actuations to be performed to enable the battery to be removed. Refer to FIGS. 2F-2L for additional details regarding stopper 270.

While illustrated in FIG. 2A as including a limited number of specific components, a battery holder in accordance with an embodiment may include fewer, additional, and/or different components than those illustrated therein.

Turning to FIGS. 2B-2C, diagrams of front isometric and rear isometric views of holder 250 in accordance with an embodiment are shown. As discussed above, holder 250 may hold a battery and connect the battery to other components while the battery is held to facilitate powering of the other components with the battery. To provide its functionality, holder 250 may include release mechanism, contacts 254, contacts 256, retention element 258, receptacle 262, and release mechanism attachment body 264. Each of these component is discussed below.

Generally, holder 250 may include a body having a recessed area in which a battery may be positioned. To connect the battery to other components, contacts 254 and 256 may be positioned with the body. Contacts 254 may make physical contact with the battery, while contacts 256 may make physical contact with other components such as a circuit board. The contacts may be interconnected with wiring or other condition paths. Any of the contacts may be spring loaded or otherwise placed under tension so that electrical connections with the battery may be reliably established when batteries are positioned in the body.

Once positioned in the body, retention elements (e.g., 258) around the body may secure a first side of the battery in place. For example, retention element 258 may be implemented using an extended portion of the body that limits travel of the battery on one end of the holder. The other end of the battery may be reversibly secured in place with retention element 260. Retention element 260 may include hooks, extensions, or other physical structures that, like retention element 258, limit travel of the battery.

However, retention element 260 may be attached to release mechanism 252. Release mechanism may enable retention element 260 to be moved so that the battery may be removed from the body. For example, release mechanism 252 may include a spring or other structure that tends to keep retention element 260 in a position that restricts motion of the battery. However, force applied by a user may overcome the force applied to retention element 260, which may cause retention element 260 to move out of the way. Refer to FIG. 2D for additional details regarding application of force to retention element 260.

Release mechanism 252 may be attached to release mechanism attachment body 264. Release mechanism attachment body 264 may be a physical structure that is complementary to and accept release mechanism 252 such that release mechanism 252 may held in a predetermined place when attached to release mechanism attachment body 264.

Release mechanism attachment body 264 may also include a receptacle (e.g., 262) or other features that enable other structures to attach to it. For example, stopper 270 may be attached to holder 250 using, at least in part, receptacle 262. Refer to FIGS. 2I-2J for additional details regarding attachment of stopper 270 to holder 250.

While illustrated in FIGS. 2B-2C as including a limited number of specific components, a holder (e.g., 250) in accordance with an embodiment may include fewer, additional, and/or different components than those illustrated therein.

Turning to FIG. 2D, a diagram of a front isometric view of circumscribing component 230 in accordance with an embodiment is shown. As discussed above, circumscribing component 230 may cover various sides of holder 250, and the battery therein, to reduce the likelihood of undesired removal of the battery from holder. To provide its functionality, circumscribing component 230 may include retention element 232, arms 234, and joint portion 236. Each of these component is discussed below.

To secure itself to holder 250, various retention elements (e.g., 232) may be included. The retention elements may include, for example, nubs or other physical structure to limit movement of circumscribing component. For example, the numbers may assist in retaining circumscribing component 230 with holder 250.

Arms 234 may include structural sidewalls that cover sides of holder 250. Arms be flexible, and may be sized to grip the outside of holder 250.

Joint portion 236 may be a portion of a joint between circumscribing component 230. For example, joint portion 236 may include holes to receive a corresponding portion of cap 210. The corresponding portion may complete a rotational joint that enables the cap to rotate about joint portion 236.

While illustrated in FIG. 2D as including a limited number of specific components, a circumscribing component in accordance with an embodiment may include fewer, additional, and/or different components than those illustrated therein.

To further clarify aspects of interplay between circumscribing component 230 and holder 250, a top view diagram in accordance with an embodiment is shown in FIG. 2E.

As seen in FIG. 2E, circumscribing component may generally surround an exterior of holder 250. Inside of holder 250, a battery may be positioned. In FIG. 2E, this area is shown with dotted infill.

When a battery is positioned in holder 250, the battery may be held fixedly in place with retention element 260 (and/or retention element 258). As seen in FIG. 2E, retention element 260 may extend above the battery while the battery is held by holder 250.

To remove the battery, a person may need to apply a force to release mechanism. The direction of application of the force is shown in FIG. 2E using an oversized arrow with white infill. Thus, the battery holder may include this first safety mechanism that reduces the likelihood of undesired removal of the battery from the battery holder.

To further secure the battery, stopper 270 may be positioned with holder 250. Turning to FIGS. 2F-2G, front and rear isometric view diagrams of stopper 270 in accordance with an embodiment are shown. As discussed above, stopper 270 may (i) fixedly secure itself to holder 250, (ii) selectively prevent the release mechanism of holder from being operated, and (iii) selectively fix cap in a closed position. To do so, stopper may include body 272, and extension elements 276. Each of these component is discussed below.

Body 272 may be a structural member for attachment to holder 250. To attach to holder, body 272 may have a shape complementary to the shape of release mechanism attachment body (e.g., 264, FIG. 2B), and include fixation element 274 and clip 282. Body 272 may generally be made of metal or other elastic material.

The shape of body 272 may enable it to flip over portions of release mechanism attachment body 264. Refer to FIG. 2I for additional details regarding slipping body 272 over release mechanism attachment body 264.

When positioned with release mechanism attachment body 264, fixation element 274 may establish an interference with receptacle 262. For example, fixation element 274 may include a bar, pin, or other structure that inserts itself into receptacle 262, and when so inserted establishes an interference that prevents stopper 270 from being detached from release mechanism attachment body 264.

Similarly, clip 282 may establish an interference with release mechanism attachment body 264 (e.g., may be on an opposite side from that established by fixation element 274.

Extension elements 276 may be structural members that extend from body 272. Each of the extension elements 276 may be attached to body 272 with joints (e.g., 279) that may allow extension elements 276 to bend away from body, and return to an at rest position when the force causing the bending is removed. Refer to FIG. 2H for additional detail regarding rotation of extension elements 276.

Each of extension elements 276 may include an interference portion (e.g., 278) for establish interferences with the release mechanism of holder 250, and a cover catch portion (e.g., 280) for securing cap 210 in place. Generally, cover catch portion 280 may be further away from body 272 than interference portion 278.

While illustrated in FIGS. 2F-2G as including a limited number of specific components, a stopper in accordance with an embodiment may include fewer, additional, and/or different components than those illustrated therein.

Turning to FIG. 2H, a rear isometric diagram of stopper 270 in accordance with an embodiment is shown (e.g., may be similar to the diagram shown in FIG. 2G). To bend extension elements 276, force may be applied by a user. The force application is illustrated with oversized arrows with white infill. When sufficient force is applied, the extension elements may bend away from body 272. The motion may cause the cap to be released (e.g., when the extension elements move from an at rest position to a first position), and then the interference with the release mechanism of holder 150 may be released (e.g., when the extension elements move from the first position to the second position, which may be further rotated away from the body). The rotation of the extension elements is shown in FIG. 2H using oversized arrows with dashed tails.

For stopper 270 to perform its function, stopper 270 may be fixed to release mechanism attachment body 264. Turning to FIG. 2I, a front isometric diagram illustrating an attachment of stopper 270 to release mechanism attachment body 264 in accordance with an embodiment is shown. As seen in FIG. 2I, stopper 270 may be aligned with release mechanism attachment body 264. Once aligned, stopper 270 may be moved down onto release mechanism attachment body 264. The movement is shown in FIG. 2H using an oversized arrow with white infill.

Once attached, stopper 270 may limit movement of cap 210 and the release mechanism of holder 250. Turning to FIG. 2J, a front isometric diagram illustrating an example assembly of the battery holder 200 in accordance with an embodiment is shown. In FIG. 2J, cap 210 is illustrated in an open position. Consequently, in this configuration, stopper 270 may only prevent the release mechanism of holder 250 from being actuated.

To do so, the interference portions of the extension elements of stopper 270 may block movement path of the release mechanism. Turning to FIG. 2K, a top view diagram illustrating the example assembly of the battery holder 200 in accordance with an embodiment is shown. As seen in FIG. 2K, when stopper 270 is positioned with holder 250, the extension elements may establish interference 290, which may prevent the release mechanism from moving in a manner that allows retention element 260 to release the battery. Thus, in this configuration, a user would need to simultaneously apply force to the extension elements to release interference 290 between the extension elements and the release mechanism for the release mechanism to be actuated to enable retention element 260 to move to release the battery. Thus, until complete, application of force to only one of these mechanisms may be insufficient to release the battery. For example, the example application of a single force as illustrated using the oversized arrow with white infill. Rather, an additional force as illustrated using the oversized arrows with dotted infill may also need to be applied for the battery to be released. Thus, two separate safety mechanisms may be in place.

In addition to these safety mechanism, cap 210 may also serve as a further safety mechanism. Turning to FIG. 2L, a front isometric diagram illustrating an example assembly of the battery holder 200 in accordance with an embodiment is shown. In FIG. 2L, cap 210 is illustrated in a closed position. Consequently, in this configuration, stopper 270 may secure cap 210 in place as well as prevent the release mechanism of holder 250 from being actuated.

For example, as seen in FIG. 2L, when cap 10 is in the closed position, a tab (e.g., 212, extension from a general disc shaped structure) of cap 210 may be secured by the extension elements. For example, the cover catch portions of the extension elements of stopper 270 may establish interference 292. Interference 292 may prevent cap from rotating about joint portion 214 (e.g., portion of cap that attaches to joint portion 236). To release interference 292, as noted above, force may need to be applied to the extension elements as illustrated in FIG. 2K.

Thus, the cap may also serve as a safety mechanism for undesired release of the battery by covering the holder for the battery, and corresponding release mechanism.

Thus, a battery holder in accordance with an embodiment may include multiple safety mechanisms that in combination reduce the likelihood of undesired releases of batteries from battery holders.

Any of the components illustrated in FIGS. 1-2L may be implemented with one or more computing devices. Turning to FIG. 3, a block diagram illustrating an example of a data processing system (e.g., a computing device) in accordance with an embodiment is shown. For example, system 300 may represent any of data processing systems described above performing any of the processes or methods described above. System 300 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 300 is intended to show a high level view of many components of the computer system. However, it is to be understood that additional components may be present in certain implementations and furthermore, different arrangement of the components shown may occur in other implementations. System 300 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 300 includes processor 301, memory 303, and devices 305-307 via a bus or an interconnect 310. Processor 301 may represent a single processor or multiple processors with a single processor core or multiple processor cores included therein. Processor 301 may represent one or more general-purpose processors such as a microprocessor, a central processing unit (CPU), or the like. More particularly, processor 301 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 301 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 301, which may be a low power multi-core processor socket such as an ultra-low voltage processor, may act as a main processing unit and central hub for communication with the various components of the system. Such processor can be implemented as a system on chip (SoC). Processor 301 is configured to execute instructions for performing the operations discussed herein. System 300 may further include a graphics interface that communicates with optional graphics subsystem 304, which may include a display controller, a graphics processor, and/or a display device.

Processor 301 may communicate with memory 303, which in one embodiment can be implemented via multiple memory devices to provide for a given amount of system memory. Memory 303 may include one or more volatile storage (or memory) devices such as random access memory (RAM), dynamic RAM (DRAM), synchronous DRAM (SDRAM), static RAM (SRAM), or other types of storage devices. Memory 303 may store information including sequences of instructions that are executed by processor 301, or any other device. For example, executable code and/or data of a variety of operating systems, device drivers, firmware (e.g., input output basic system or BIOS), and/or applications can be loaded in memory 303 and executed by processor 301. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 300 may further include IO devices such as devices (e.g., 305, 306, 307, 308) including network interface device(s) 305, optional input device(s) 306, and other optional IO device(s) 307. Network interface device(s) 305 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 306 may include a mouse, a touch pad, a touch sensitive screen (which may be integrated with a display device of optional graphics subsystem 304), a pointer device such as a stylus, and/or a keyboard (e.g., physical keyboard or a virtual keyboard displayed as part of a touch sensitive screen). For example, input device(s) 306 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 307 may include an audio device. An audio device may include a speaker and/or a microphone to facilitate voice-enabled functions, such as voice recognition, voice replication, digital recording, and/or telephony functions. Other IO devices 307 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 307 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 310 via a sensor hub (not shown), while other devices such as a keyboard or thermal sensor may be controlled by an embedded controller (not shown), dependent upon the specific configuration or design of system 300.

To provide for persistent storage of information such as data, applications, one or more operating systems and so forth, a mass storage (not shown) may also couple to processor 301. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 301, e.g., via a serial peripheral interface (SPI). This flash device may provide for non-volatile storage of system software, including a basic input/output software (BIOS) as well as other firmware of the system.

Storage device 308 may include computer-readable storage medium 309 (also known as a machine-readable storage medium or a computer-readable medium) on which is stored one or more sets of instructions or software (e.g., processing module, unit, and/or processing module/unit/logic 328) embodying any one or more of the methodologies or functions described herein. Processing module/unit/logic 328 may represent any of the components described above. Processing module/unit/logic 328 may also reside, completely or at least partially, within memory 303 and/or within processor 301 during execution thereof by system 300, memory 303 and processor 301 also constituting machine-accessible storage media. Processing module/unit/logic 328 may further be transmitted or received over a network via network interface device(s) 305.

Computer-readable storage medium 309 may also be used to store some software functionalities described above persistently. While computer-readable storage medium 309 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 328, components and other features described herein can be implemented as discrete hardware components or integrated in the functionality of hardware components such as ASICS, FPGAs, DSPs or similar devices. In addition, processing module/unit/logic 328 can be implemented as firmware or functional circuitry within hardware devices. Further, processing module/unit/logic 328 can be implemented in any combination hardware devices and software components.

Note that while system 300 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A data processing system, comprising:
hardware components; and
a battery holder for a coin cell battery, the battery holder comprising:
a holder to secure the coin cell battery in the battery holder, the holder comprising a release mechanism to release the battery using an application of a first force; and
a stopper adapted to prevent the application of the first force from releasing the battery unless a second force is applied to the stopper while the first force is applied to the release mechanism.

2. The data processing system of claim 1, wherein the battery holder further comprises:
a cover set to cover sides and a top of the coin cell battery.

3. The data processing system of claim 2, wherein the cover set comprises:
a circumscribing component to cover the sides of the battery holder; and
a cap to cover the top of the battery holder.

4. The data processing system of claim 3, wherein the cap is rotatably coupled to the circumscribing component on a first side and is reversibly secured to the stopper on a second side.

5. The data processing system of claim 1, wherein the stopper comprises:
a body adapted for attachment to the holder;
a pair of extension elements that extend from the body, the pair of extension elements being adapted to:
move to an at rest position while the second force is not applied, and the pair of extension elements establishing an interference with the release mechanism while in the at rest position.

6. The data processing system of claim 5, wherein an extension of the pair of extensions comprises:
a cover catch portion adapted to reversibly secure the cover in a closed position;
an interference portion adapted to, at least in part, establish the interference with the release mechanism; and
a joint to rotate the cover catch portion and the interference portion between three positions.

7. The data processing system of claim 6, wherein, while the cover catch portion is in a first position of the three positions, the cover catch portion establishes an interference with a tab of the cover that retain the cover in the closed position.

8. The data processing system of claim 7, wherein, while the cover catch portion is in either of a second position and a third position of the three positions, the interference with the tab of the cover is released to allow the cover to move to an open position.

9. The data processing system of claim 8, wherein, while the interference portion is in either of the first position and the second position of the three positions, the interference portion establishes the interference with the release mechanism.

10. The data processing system of claim 9, wherein, while the interference portion is in the third position of the three positions, the interference with the release mechanism is released to enable actuation of the release mechanism.

11. A battery holder for a coin cell battery, the battery holder comprising:
a holder to secure the coin cell battery in the battery holder, the holder comprising:
a release mechanism to release the battery using an application of a first force, and
electrical contacts to interconnect the coin cell battery with a circuit board; and
a stopper adapted to prevent the application of the first force from releasing the battery unless a second force is applied to the stopper while the first force is applied to the release mechanism.

12. The battery holder of claim 11, further comprising:
a cover set to cover sides and a top of the coin cell battery.

13. The battery holder of claim 12, wherein the cover set comprises:
a circumscribing component to cover the sides of the battery holder; and
a cap to cover the top of the battery holder.

14. The battery holder of claim 13, wherein the cap is rotatably coupled to the circumscribing component on a first side and is reversibly secured to the stopper on a second side.

15. The battery holder of claim 11, wherein the stopper comprises:
a body adapted for attachment to the holder;
a pair of extension elements that extend from the body, the pair of extension elements being adapted to:
move to an at rest position while the second force is not applied, the pair of extension elements establishing an interference with the release mechanism while in the at rest position.

16. The battery holder of claim 15, wherein an extension of the pair of extensions comprises:
a cover catch portion adapted to reversibly secure the cover in a closed position;
an interference portion adapted to, at least in part, establish the interference with the release mechanism; and
a joint to rotate the cover catch portion and the interference portion between three positions.

17. The battery holder of claim 16, wherein, while the cover catch portion is in a first position of the three positions, the cover catch portion establishes an interference with a tab of the cover that retain the cover in the closed position.

18. The battery holder of claim 17, wherein, while the cover catch portion is in either of a second position and a third position of the three positions, the interference with the tab of the cover is released to allow the cover to move to an open position.

19. The battery holder of claim 18, wherein, while the interference portion is in either of the first position and the second position of the three positions, the interference portion establishes the interference with the release mechanism.

20. The battery holder of claim 19, wherein, while the interference portion is in the third position of the three positions, the interference with the release mechanism is released to enable actuation of the release mechanism.
